(19) United States
(12) Patent Application Publication
(10) Pub. No.: US 2025/0091948 A1
(43) Pub. Date: Mar. 20, 2025

(54) CEMENTITIOUS COMPOSITE MATERIALS CO-CONTAINING POLY VINYL ALCOHOL WATER CARRIERS AND REINFORCED FIBERS AND METHOD FOR MAKING THEREOF

(71) Applicant: Feng-An Tsai, Taipei City (TW)

(72) Inventor: Feng-An Tsai, Taipei City (TW)

(21) Appl. No.: 18/370,659

(22) Filed: Sep. 20, 2023

(51) Int. Cl. C04B 24/26; C04B 14/06; C04B 16/06; C04B 24/38; C04B 28/04; C04B 40/00; C04B 103/30; C04B 103/40

(52) U.S. Cl. CPC C04B 24/2623; C04B 14/06; C04B 16/0641; C04B 24/383; C04B 28/04; C04B 40/0046; C04B 2103/302; C04B 2103/408

(57) ABSTRACT

A cementitious composite includes a cementitious binder; water; from 0.5 to 2.0 vol % of polymer fibers; water reducing agents; and PVA (polyvinyl alcohol) porous water carriers different than the polymer fibers; wherein the cementitious composite has a weight ratio of the water to the cementitious binder in a range of 0.30:1 to 0.55:1, a weight ratio of the PVA porous powder water carriers to the cementitious binder in a range of 0.005:1 to 0.03:1, and a weight ratio of the water reducing agents to the cementitious binder in range of 0.001:1 to 0.05:1.

### FIELD OF THE DISCLOSURE

This invention relates to polymer fiber reinforced cementitious composite containing polyvinyl alcohol (PVA) water carriers. The PVA water carriers can not only improve polymer fibers' dispersion uniformity inside the materials through bridging polymer fibers with other ingredients in interfacial transition zones like water, gel water, and cementitious binder gel but also release water molecules during the hardening process for a purpose for water-binder hydration. The materials can be extensively applied in building materials like fiber-modified cement pastes and mortars, fiber-reinforced concretes, and recycled aggregates containing sustainable materials.

### BACKGROUND OF THE DISCLOSURE

Conventional cementitious composite materials, such as cement pastes, mortars, concretes, and the like, have been developed and variously applied in fields of modern construction. With the evolution of modern technology, cementitious composite materials can be strong enough in compression strength. However, these materials still bear a brittle nature and are relatively weak in tension. Their tensile strength provides low resistance to crack propagation, which may lead to lower ductility and durability of construction materials. For example, higher-strength concrete is usually more brittle than normal-strength concrete, causing a higher tendency to undergo sudden fracture failure under an extreme loading such as Mw>7.0 earthquakes. Essentially, pursuing even higher compression strength in constructing materials and promoting materials' toughness and ductility are two distinct challenges; hence, we should systematically consider them simultaneously while designing the material structure.

To tune the brittle nature of the materials, reinforcement materials that are excellent in tension and able to bridge micro-cracks need to be designed to be embedded into the composite materials to support their tensile properties, wherein the reinforced materials are generally termed fiber-reinforced cementitious composites (FRCC) or fiber reinforced concretes with coarse aggregates (FRC) and one specific group among them called engineered cementitious composite (ECC) including fly ash and fine aggregates. Normally, the fibers are embedded in cementitious composite materials with a volume up to 5.0 vol % with respect to total material volume or in terms of weight percent with respect to cementitious binders. Commercially available fibers are steel fibers, glass fibers like silica and basalt, synthetic polymer fibers like polyvinyl alcohol (PVA), polypropylene (PP), polyoxymethylene (POM), carbon fibers, carbon nanotubes, polyethylene (PE), and natural fibers like straw. Among all, synthetic polymer fibers are usually applied from an economical point of view.

Currently, reinforced polymer fiber dispersion uniformity in related materials is crucial in achieving desired mechanical strength performances. According to the prior art, U.S. Pat. No. 8,697,780 to Paul E. Bracegirdle, if reinforcement fibers are not uniformly distributed within the concrete, the fibers may create defects in the composition of the concrete, and the number of defects will be proportional to the amount of the fibers being used. Also, once the polymer fibers volumes are increased to a certain amount, there is a tendency that some polymeric fibers may aggregate and form clumps with sand and cement paste where no water molecules surround them; hence, the hydration hardening reaction cannot be generated. A non-uniform distribution of fibers inside cementitious composite materials during manufacturing may cause a negative influence on structure durability, jeopardizing the structure's safety and reducing its service life. Furthermore, material product failure will lead to extra costs and potential environmental impact since they should be removed, recycled, and remade.

There were various approaches to managing the fiber dispersion in cementitious composite materials, trying to fix the issue aiming for wide commercial use. Acrylic dispersion in the amount of 15 wt % by mass of cement was proposed. Also, using an optimal amount of viscosity modifying agent (VMA), such as adding methyl cellulose thickening agent or tuning the number of superplasticizers, has been proposed to be one of the approaches to manage PVA fiber dispersion. Another way to improve PVA fiber dispersion in cement mortar is to utilize non-ionic polyoxyethylene ether to modify the surface properties of fibers.

According to prior art, U.S. Pat. No. 6,809,131 B2 to Victor C. Li, the PVA fiber surface can be coated with an oiling agent before making ECC. It is vital to make sure that those approaches are feasible since the workability of fresh materials is important for on-site working. Nevertheless, mixing fiber dispersion uniformity during fresh composite materials and controlling fiber dispersion uniformity during the material hardening process may contradict each other. As materials are fresh and still not setting (going to harden), relatively lower viscosity, somehow resembling higher workability on processing work site, is generally required. The above approaches may decrease fresh material's workability. Furthermore, increasing fiber volume fraction and aspect ratio potentially decreases the workability of cementitious composite materials. During the setting and hardening period of cementitious composite materials, preventing fibers from flowing to the upper section of the materials due to fibers' relatively lightweight (relatively low density) or inhibiting fibers' agglomeration, on the contrary, it may require higher viscosity of materials to physically bound polymer fibers inside the cementitious composite material matrix. Based on the above review, the major challenge of making fiber-reinforced cementitious materials with excellent and stable mechanical performance is to manage the design dilemma well: to devise a practically feasible way to compromise fresh flow properties without interfering with the hardening process. Furthermore, the proposed solution should have an economically competitive advantage from the commercial point of view. Those requirements can be accomplished by the present invention as described and claimed below.

All referenced patents, applications and literature are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, a cementitious composite comprises a cementitious binder; water; from 0.5 to 2.0 vol % of polymer fibers; water reducing agents; and PVA (polyvinyl alcohol) porous water carriers different than the polymer fibers, wherein the cementitious composite has a weight ratio of the water to the cementitious binder in a range of 0.30:1 to 0.55:1, a weight ratio of the PVA porous powder water carriers to the cementitious binder in a range of 0.005:1 to 0.03:1, and a weight ratio of the water reducing agents to the cementitious binder in a range of 0.001:1 to 0.05:1.

Among the many possible implementations of the cementitious composite, wherein the cementitious composite has a weight ratio of viscosity modifying agents to the cementitious binder in a range of 0.0014:1 to 0.025:1 and a weight ratio of aggregates to the cementitious binder in a range of 0.01:1 to 9:1, and a weight ratio of chemical ingredients including slump keeper, retarder, de-foaming agents or a combination thereof to the cementitious binder in a range of 0.001:1 to 0.025:1.

Further, it is contemplated that the polymer fibers comprise a tenacity of 1.0 to 1.6 GPa, an elongation of 6-9.5%, a Modulus of 27 GPa to 41 GPa, a diameter of 20 to 220 μm, and a length of 5 to 15 mm.

In another aspect combinable with the general implementation, the viscosity modifying agent comprises methyl propyl cellulose.

In the alternative, the water reducing agents comprise solid contents of above 20 wt % by the total weight of the water reducing agents and are selected from the group consisting of polycarboxylate (PCE), polycarbonate, lignosulfonate, sodium naphthalene sulfonate-formaldehyde condensate, melamine sulfonate-formaldehyde condensate, poly-alkylaryl sulfonate and a combination thereof.

It is still further contemplated that the PVA porous water carriers comprise PVA powder, pellet, or particles wetted by water or organic solvents with C—OH functional group, wherein the PVA powders, pellets, or particles have a degree of polymerization (DP) from 1000 to 2500 and a degree of hydrolysis value (HV, mole %) from 87.0 mole % to 99.9 mole %.

In another aspect combinable with the general implementation, the aggregates comprise fine aggregates and coarse aggregates, wherein the fine aggregates comprise sands with ASTM standards 20/30 nm and recycled aggregates, and the coarse aggregates comprise stones and gravels.

In another aspect combinable with the general implementation, the cementitious binder has an average particle diameter from 4.5 to 16.0 mm and is selected from a group consisting of Portland type I cement, Portland type II cement, Portland type III cement, lime, slag, flying ash, refractory cement, pozzolanic cement, and a combination thereof.

In another aspect combinable with the general implementation, the chemical ingredients are selected from a group consisting of chemicals bringing hydroxyl groups (R—OH), saccharides, monosaccharides including glucose, fructose, galactose, saccharose, xylose, apiose, and ribose and high-fructose corn syrup, oligosaccharides including di-saccharides and tri-saccharides, oligosaccharides including dextrin, and polysaccharides including dextran, and refinery saccharides, sugar alcohols including sorbitol polyhydric alcohols and glycerin and a combination thereof.

In another aspect combinable with the general implementation, the cementitious composite further comprises a weight ratio of the PVA (polyvinyl alcohol) porous water carriers to the polymer fiber from 1:1 to 1.5:1.

Another aspect of the embodiment is directed to methods of making a cementitious composite, comprising:
blending a cementitious binder and selectively aggregates to form a dry mixture;
separately blending polymer fibers and PVA porous water carriers different than the polymer fibers in a mixer to form a reinforced mixture;
blending water, water-reducing agents, the dry mixture, and the reinforced mixture to form a polymer fiber reinforced mixture;
molding, hardening, and demolding the polymer fiber-reinforced mixture to form a cementitious composite, wherein
the cementitious composite has from 0.5 to 2.0 vol % of polymer fibers, a weight ratio of the water to the cementitious binder of 0.3:1 to 0.55:1, a weight ratio of the PVA porous powder water carriers to the cementitious binder of 0.005:1 to 0.03:1, and a weight ratio of water reducing agents to the cementitious binder in a range of 0.001:1 to 0.05:1.

In another aspect combinable with the general implementation, the method may further comprise a step of adding the viscosity modifying agents, including methyl propyl cellulose, to the reinforced mixture, wherein the cementitious composite has a weight ratio of the viscosity modifying agent to the cementitious binder in a range of 0.0014:1 to 0.025:1, and a weight ratio of aggregates to the cementitious binder in a range of 0.01:1 to 9:1.

In another aspect combinable with the general implementation, the water reducing agents comprise solid contents above 20 wt % by the total weight of the water-reducing agents and are selected from the group consisting of polycarboxylate (PCE), polycarbonate, lignosulfonate, sodium naphthalene sulfonate-formaldehyde condensate, melamine sulfonate-formaldehyde condensate, poly-alkylaryl sulfonate and a combination thereof.

In another aspect combinable with the general implementation, the aggregates comprise fine aggregates, including sands with ASTM standards 20/30 nm and recycled aggregates, and coarse aggregates, including stones and gravels.

In another aspect combinable with the general implementation, the method may further comprise a step of adding the chemical ingredients, including slump keeper, retarder, de-foaming agents, or a combination thereof to the reinforced mixture, wherein a weight ratio of the chemical ingredients to the cementitious binder in range of 0.001:1 to 0.025:1.

In another aspect combinable with the general implementation, the chemical ingredients are selected from a group consisting of chemicals bringing hydroxyl groups (R—OH), saccharides, monosaccharides including glucose, fructose, galactose, saccharose, xylose, apiose, and ribose and high-fructose corn syrup, oligosaccharides including di-saccharides and tri-saccharides, oligosaccharides including dextrin, and polysaccharides including dextran, and refinery saccharides, sugar alcohols including sorbitol polyhydric alcohols and glycerin and a combination thereof.

In another aspect combinable with the general implementation, the method may further comprise a step of pre-wetting PVA powder, pellet, or particles by water or organic solvents with C—OH functional group to form PVA porous water carriers, wherein the PVA powders, pellets, or particles have a degree of polymerization (DP) from 1000 to 2500 and a degree of hydrolysis value (HV, mole %) from 87.0 mole % to 99.9 mole %.

In another aspect combinable with the general implementation, the cementitious composite comprises a weight ratio of the PVA (polyvinyl alcohol) porous water carriers to the polymer fibers from 1:1 to 1.5:1.

In another aspect combinable with the general implementation, the polymer fibers comprise a tenacity of 1.0 to 1.6 GPa, an elongation of 6-9.5%, a Modulus of 27 GPa to 41 GPa, a diameter of 20 to 220 μm, and a length of 5 to 15 mm.

In another aspect combinable with the general implementation, the cementitious binder has an average particle diameter from 4.5 to 16.0 mm and is selected from a group consisting of Portland type I cement, Portland type II cement, Portland type III cement, lime, slag, flying ash, refractory cement, pozzolanic cement, and a combination thereof.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be too precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a schematic drawing showing the difference in fiber distribution phenomena inside cementitious composite without having PVA porous water carriers and with PVA porous water carriers with the same weight ratio of the water to the cementitious binder according to an aspect of the embodiment.

FIG. 2A is a photograph of the fracture surface of PVA fiber of 1.15 vol % in the cementitious composite material according to an aspect of the embodiment.

FIG. 2B is a photograph of the fracture surface of PVA polymer fiber (1.17 vol %) in the cementitious composite material with PVA porous water carriers according to an aspect of the embodiment.

FIGS. 3A-3C are examples of observing fibers' dispersion phenomena in water according to an aspect of the embodiment.

FIG. 4A illustrates the cementitious composite according to an aspect of the embodiments.

FIG. 4B shows that the cementitious composites of FIG. 4A evaluated by the material compression strength and the material tensile strength according to an aspect of the embodiment.

FIGS. 5A-5B illustrates a combination of two kinds of fibers in the cementitious composite according to an aspect of the embodiments.

FIGS. 6A-6B illustrate the comparations between adding the PVA porous water carriers and adding the viscosity modifying agent: methyl propyl cellulose (MC) in the cementitious composite according to an aspect of the embodiments.

FIG. 7 illustrates that the PVA porous water carriers may cause the polyoxymethylene (POM) fibers to be well dispersed in the water according to an aspect of the embodiments.

FIG. 8 illustrates that the PVA porous water carriers may cause the polyoxymethylene (POM) fibers and PVA fibers to be well dispersed in the water according to an aspect of the embodiments.

FIGS. 9A-9B illustrate that the cementitious composite may have polymer fibers or without having polymer fibers according to an aspect of the embodiments.

FIGS. 10A-10B illustrate that the cementitious composite without having aggregates according to an aspect of the embodiments.

FIG. 11 generally depicts a method of making the cementitious composite according to an aspect of the embodiments.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

Fiber-reinforced cementitious composite serves as green building materials that undoubtedly drive construction infrastructure durability and sustainability. The invention aims to disclose an economically feasible and environmentally friendly way to resolve polymer fiber dispersion issues during inventive materials' manufacturing. Those are polymer fibers reinforced cementitious composite containing PVA porous water carriers, which can improve polymer fibers' dispersion uniformity inside the materials through bridging polymer fibers with other ingredients in interfacial transition zones like water, gel water, and cementitious binder gel. PVA water carriers also carry water molecules and release them during the material hardening process; hence the materials can have desired mechanical properties according to the intended application specification. The well-dispersed fiber in the materials also indicates a potential decrease of fiber content while keeping the materials' excellent mechanical properties, therefore having an economically competitive advantage.

It should be noted that the fresh, still non-hardening cementitious composites such as cement paste, mortar, or concrete can be generally viewed as a non-Newtonian fluid, and the modified Bingham fluid model is generally utilized to express their flowing rheology. According to the model, fresh cementitious composite must overcome yield stress before it starts to flow. Once it comes to flow, shear stress varies with a strain rate. First of all, as referred from the model expression, it is necessary to have an initial yield stress to support relatively lightweight polymer fibers uniformly dispersing inside much denser non-hardening composite material slurry mixtures such as cement, slags, flying ashes, silica, fine aggregates including sands, and coarse aggregates including stones and gravels. Note that as these composite materials are statically suspended in the water zone, their yield stress is generated from cohesive forces such as intermolecular hydrogen bonding and long-range electrostatic forces among cementitious materials, aggregates, fibers, and water molecules. When the fresh cementitious composite is flowing or as they are poured in the specified solid mold, it may be anticipated for shear thinning flow behavior, resembling relatively lower viscosity or higher workability with mechanical shear stress. Meanwhile, under the circumstance of moving composite materials with relatively lower viscosity, it is also necessary to keep fibers well dispersed in slurry mixtures until they are fully filled in the mold and finally to be set and harden, indicating it requires some intrinsic force from materials' interaction to make fibers not occur agglomeration or clumping phenomena.

The incorporation of PVA water carriers inside fiber reinforced cementitious composite materials can balance the natural tendency of polymer fiber agglomeration. PVA molecules have many hydroxyl groups generating both intra-molecular and inter-molecular hydrogen bonding in the zone with water molecules. Utilizing porous PVA's intrinsic properties, PVA water carriers can physically “bundling” polymer fibers effectively in the interfacial transition zone like water, gel water, and cementitious binder gel. Regarding to cementitious composite materials flow under mechanical force like mixing and pumping, the PVA water carriers which are convinced by the inventor of “soft outer shell and hard inner core” or “porous” conformation work with water molecules bringing all ingredients inside cementitious composite materials to perform like shear thinning flow behavior while slurries keep good dispersion of polymer fibers. As cementitious ingredients develop the mechanical strength of the materials through hydration hardening, the PVA molecules network with water molecules inside continuously release water molecules to the interfacial zone surrounding cementitious binder ingredients. With the support of hardening hydration heat, the PVA molecules may subsequently be dissolved into the interfacial transition water and gel water zone. The above phenomena could prevent the material's inner structure from potential autogenous shrinkage, hence potentially leading to the lower intrinsic crack formation of materials.

For massive utilization of current inventive materials in modern building projects, safety, sustainability, environmental impact, and economic competitiveness should be considered comprehensively. It is foreseeable that, replacing some amount of relatively expansive fibers with the PVA water carriers inside reinforced cementitious composite materials with improving materials' mechanical performance compared with that conventional one has economically competitive advantage. Note that polymer fibers are usually made from their powder extrusion or molten polymeric high temperature extrusion die spinning; hence they offer relatively high product prices. Stable adopting inventive materials with uniform reinforced fiber dispersion, wherein the adverse effects on mechanical performance due to too many non-useful fibers adducts or non-uniform fibers distributed in cementitious composite materials, potentially decrease the failure of building materials, thus decreasing the loading of environment.

The present invention is a cementitious composite comprising a mixture of cementitious binders, reinforced fibers (polymer fibers), chemical admixtures, PVA porous water carriers, aggregates, and water and a method of making thereof. Cementitious binders contain but are not limited to, Portland type I cement, Portland type II cement, Portland type III cement, lime, slag, flying ash, refractory cement, pozzolanic cement, and a combination thereof. In addition to the aforementioned composites, based on the required standard of building materials, the cementitious composite may comprise aggregates, including coarse and fine aggregates, such as sands, gravels, stones with various sizes, chemical admixtures containing water reducers, slump keepers, hydration retarders or hydration accelerators, antifoaming or de-foaming agents, viscosity modifying agents, early strength additives, and PVA water carriers. Reinforced fibers (polymer fibers) may be added to the above-mixed ingredients to form the cementitious composite.

The cementitious composite may comprise a cementitious binder, water, from 0.5 to 5.0 vol %, more preferably from 0.5 to 3.0 vol %, even more preferably from 0.5 to 2.0 vol % of polymer fibers, water reducing agents, and PVA (polyvinyl alcohol) porous water carriers different than the polymer fibers.

In some embodiments, the cementitious composite comprises a weight ratio of the water to the cementitious binder in a range of 0.25:1 to 0.60:1, and more preferably, 0.30:1 to 0.55:1, a weight ratio of the PVA porous powder water carriers to the cementitious binder in a range of 0.005:1 to 0.05:1, more preferably from 0.005:1 to 0.03:1, and a weight ratio of the water reducing agents to the cementitious binder in a range of 0.001:1 to 0.05:1.

In some embodiments, the cementitious composite comprises a weight ratio of the viscosity modifying agents to the cementitious binder in a range of 0 to 0.025:1, a weight ratio of the aggregates to the cementitious binder in a range of 0.001 to 9:1, and a weight ratio of the chemical ingredients to the cementitious binder in a range of 0.001:1 to 0.025:1.

It should be noted that, in some embodiments, the chemical ingredients may comprise slump keeper, retarder, or a combination thereof, wherein a weight ratio of the chemical ingredients to the cementitious binder is in the range of 0.001:1 to 0.025:1.

In still some embodiments, the water reducing agents may be selected from the group consisting of polycarboxylate (PCE), polycarbonate, lignosulfonate, sodium naphthalene sulfonate-formaldehyde condensate, melamine sulfonate-formaldehyde condensate, poly-alkylaryl sulfonate and a combination thereof, wherein polycarboxylate (PCE) is mainly a combination of acrylate or methyl methacrylate, polyether or polyester or polycarbonate-ester, and other functional monomers like maleic anhydride.

Accordingly, in some embodiments, the water reducing agents may comprise solid contents from 20 wt % to 60 wt % by the total weight of the water reducing agents and water with proprietary additives from 40 wt % to 80 wt %, depending on the suppliers and demonstrating some positive effects on water reducing performance. In still some embodiments, the water reducing agent may comprise solid contents above 99 wt % by the total weight of the water reducing agents, wherein the solid contents may be consisting of active PCE polymers and solid fillers which form as powder or solid forms like powders or pellets.

In still some embodiments, the chemical ingredients may be selected from a group consisting of chemicals bringing hydroxyl groups (R—OH), saccharides, monosaccharides including glucose, fructose, galactose, saccharose, xylose, apiose, and ribose and high-fructose corn syrup, oligosaccharides including di-saccharides and tri-saccharides, oligosaccharides including dextrin, and polysaccharides including dextran, and refinery saccharides, sugar alcohols including sorbitol polyhydric alcohols and glycerin and a combination thereof.

According to the above embodiments, the chemical ingredients may be used to tune cementitious composite rheological behavior and hardened period which can meet various application requirements.

In some embodiments, the cementitious composite may comprise the weight ratio of the viscosity modifying agent to the cementitious binder in the range of not higher than 0.025:1, wherein the viscosity modifying agent may comprise methyl propyl cellulose, wherein the viscosity modifying agent (VMA) may be functioned as tuning fresh materials' flowability.

In still some embodiments, the aggregates may comprise fine aggregates and coarse aggregates, wherein the fine aggregates comprise sands with ASTM standards 20/30 nm and recycled aggregates, and the coarse aggregates comprise stones and gravels.

In still some embodiments, for example, in construction, fine aggregates may be the fillers or particles that pass through a 4.75 mm sieve and retain on a 0.075 mm sieve, and the coarse aggregates may be the fillers or particles whose size are greater than 4.75 mm.

In still some embodiments, the cementitious composite may without have viscosity modifying agents including methyl propyl cellulose and/or aggregates, including fine aggregates and coarse aggregates.

Fine aggregates like sands and RCAs can be added into the composite where a weight ratio of the fine aggregates to the cementitious binder can be set from 0.001:1 to 9:1, and preferably 1:1. Coarse aggregates like stones and gravels can be added into the composite where a weight ratio of the fine aggregates to the cementitious binder ratio can be set from 0.001:1 to 9:1, and preferably 1:1.

In some embodiments, the polymer fibers may be PVA fibers and POM fibers having a tenacity of 1.0 to 1.6 GPa, an elongation of 6-9.5%, a Modulus of 30 GPa to 40 GPa, a diameter of 20 to 220 μm, and a length of 5 to 15 mm.

In some embodiments, the PVA porous water carriers may comprise PVA (polyvinyl alcohol) powders, pellets, or particles wetted by water or organic solvents with C—OH functional group (with carbon and hydroxyl (R—OH) structures) to make the outer shells of the PVA powders, pellets, or particles become “softer,” and at this situation, the water molecules may penetrate in and out from PVA powders, pellets, or particles.

In some embodiments, the PVA powders, pellets, or particles may be prepared by polymerization of vinyl acetate monomer (VAM) to form polyvinyl acetate (PVAc) followed by saponification of PVAc to form polyvinyl alcohol. VAM may be polymerized to polyvinyl acetate by solution polymerization with methanol as the solvent. The remaining polymer solution may be then saponified in sodium hydroxide-methanol solution, and after that, the solvents may be stripped off, and the PVA may be formed as powders via further processing.

In still some embodiments, the PVA powders, pellets, or particles may comprise physical chemical features: degree of polymerization (DP) standing for PVA molecular weight) and degree of hydrolysis value (HV, mole %), expressing as PVA structural repeating units —(CH2-CHOH)— divided by all units comprising PVA structure (—(CH2-CHOH)—+—(CH2(OCOCH3)-CH)—). In still some embodiments, the DP of porous PVA may range from 100 to 10000, preferably from 500 to 3000, and more preferably from 1000 to 2500. The HV of PVA powders may range from 38.0 mole % to 99.9 mole %, preferably from 72.5 mole % to 99.9 mole %, more preferably from 87.0 mole % to 99.9 mole %. In still some embodiments, since there can be some modification of PVA structure with a series of unsaturated acids and derivative salts selected from acrylic acid, methacrylic acid and their sodium or potassium salts, the modified PVA products are also suited for current invention.

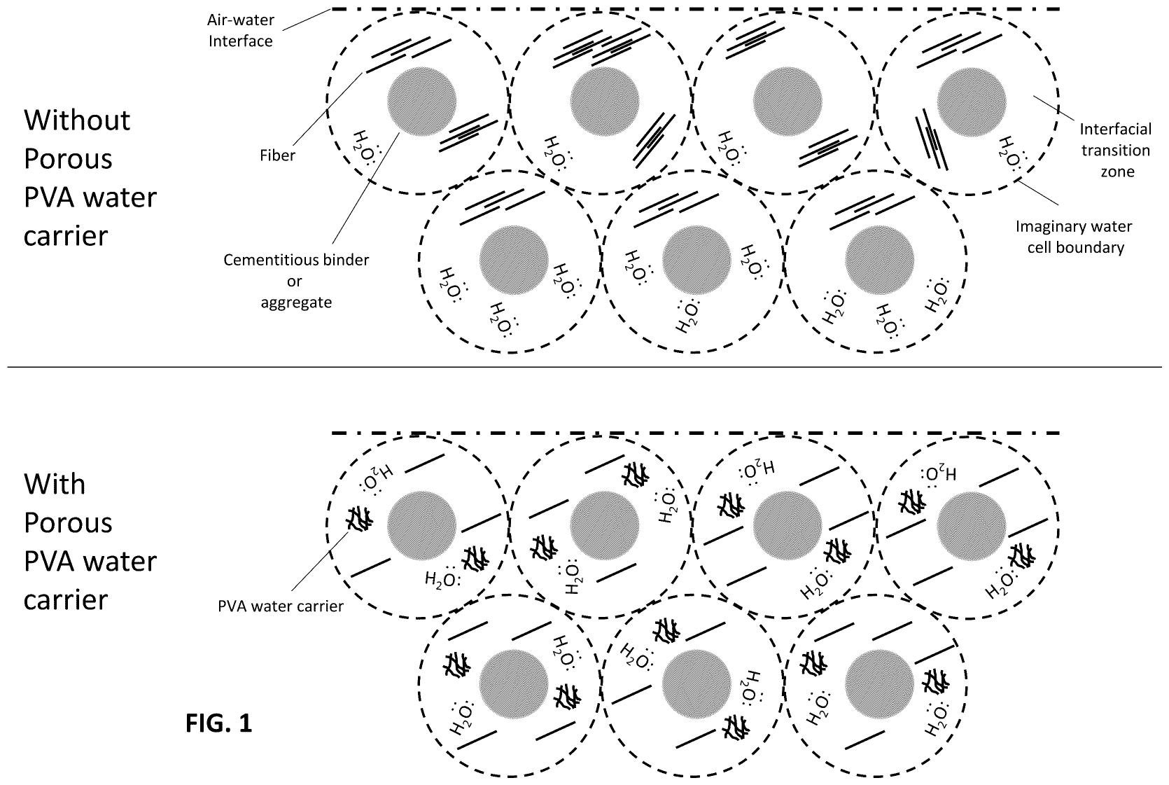

Referring to FIG. 1 of the drawings, both cement (cementitious binder) and polymer fibers may be suspended in water with the presence of PVA porous water carriers, wherein the PVA porous water carriers may be described as concentrated colloidal suspension in a porous medium. An inter-molecular attraction may be generated between PVA porous water carriers and polymer fibers, and in such a way, the PVA porous water carriers may bring the polymer fibers together and disperse inside the medium. Under loading like mechanical mixing which generates shear stress, once it overcomes the yield stress, all ingredients in the cementitious composite start flowing. Due to the still-existing attraction between PVA porous water carriers and polymer fibers, the homogeneous dispersion of fresh cementitious composite during flowing may be discovered and the segregation phenomena may not be observed.

In some embodiments, the cementitious binder may have an average particle diameter from 4.5 to 16.0 mm and may be selected from a group consisting of Portland type I cement, Portland type II cement, Portland type III cement, lime, slag, flying ash, refractory cement, pozzolanic cement, and a combination thereof.

In some embodiments, the cementitious composite may comprise a weight ratio of PVA (polyvinyl alcohol) porous water carriers to the polymer fibers in a range of 0.5:1 to 3:1, and preferably 1:1 to 1.5:1.

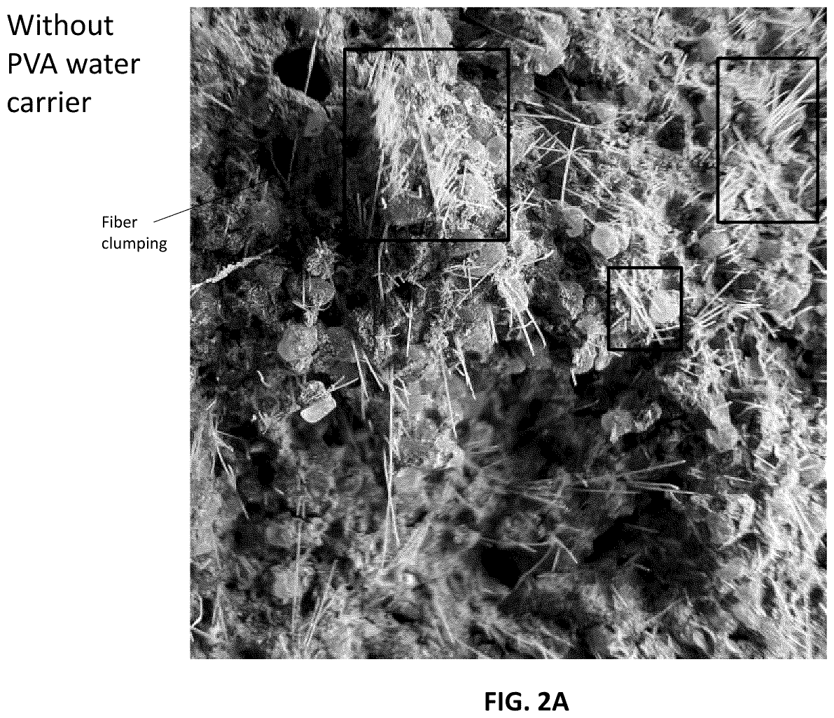

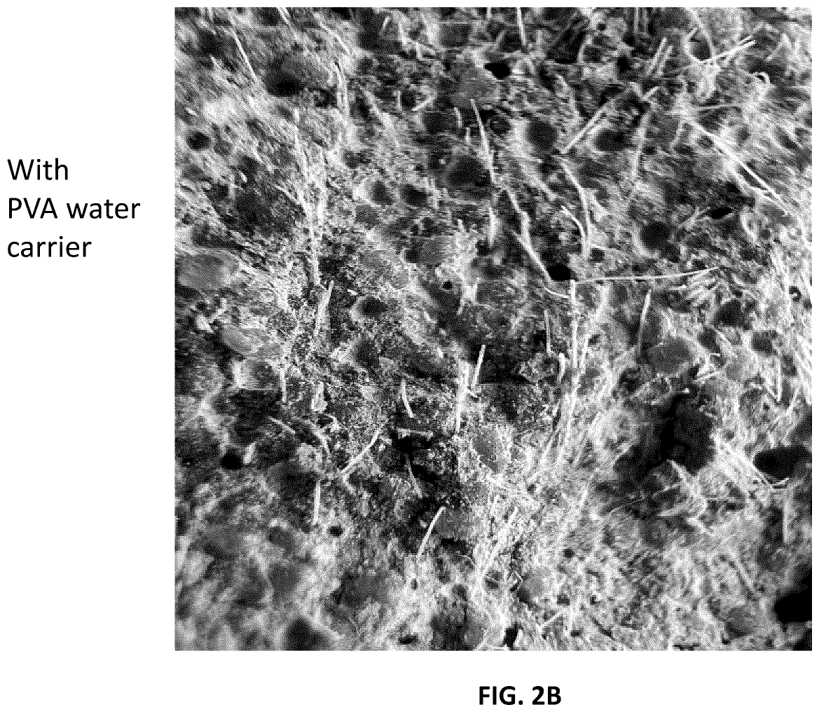

FIG. 2A and FIG. 2B show a comparison of the cementitious composite with and without the PVA porous water carriers.

Referring to FIG. 2A, the cementitious composite may comprise PVA fiber (1.15 vol %) and a weight ratio of the water to the cementitious binder of 0.49:1. It should be noted that the cementitious composite may comprise the ingredients mentioned above, including a mixture of cementitious binders, reinforced fibers (polymer fibers), chemical admixtures (chemical ingredients, the viscosity modifying agents, the chemical ingredients, the water reducing agents, aggregates, and water), wherein all the ingredients in the cementitious composite may be as mentioned above except without including the PVA porous water carriers. As shown in further details in FIG. 2A, the cementitious composite has no PVA porous water carriers, and in this situation, the PVA fiber may be clumped.

Referring to FIG. 2B, the cementitious composite may comprise PVA fiber (1.15 vol %), a weight ratio of the water to the cementitious binder of 0.49:1, and 1.1 wt % of PVA porous water carriers by weight of the whole cementitious composite, and in such a way, the PVA fiber may be well dispersed.

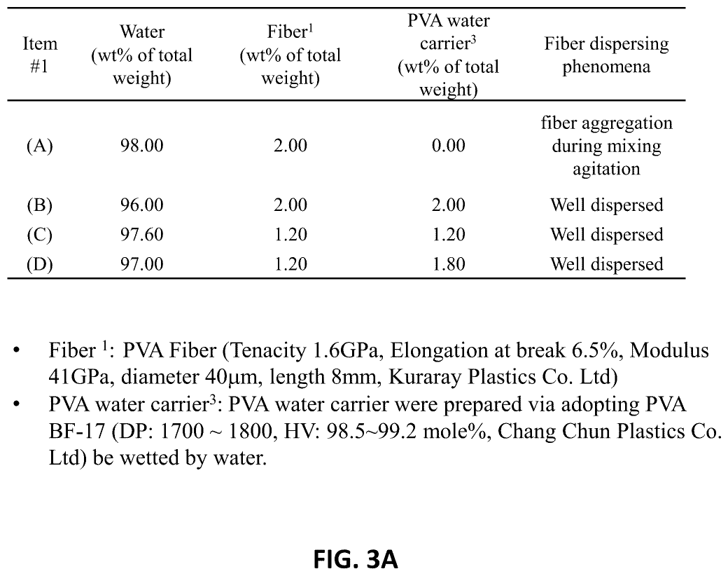

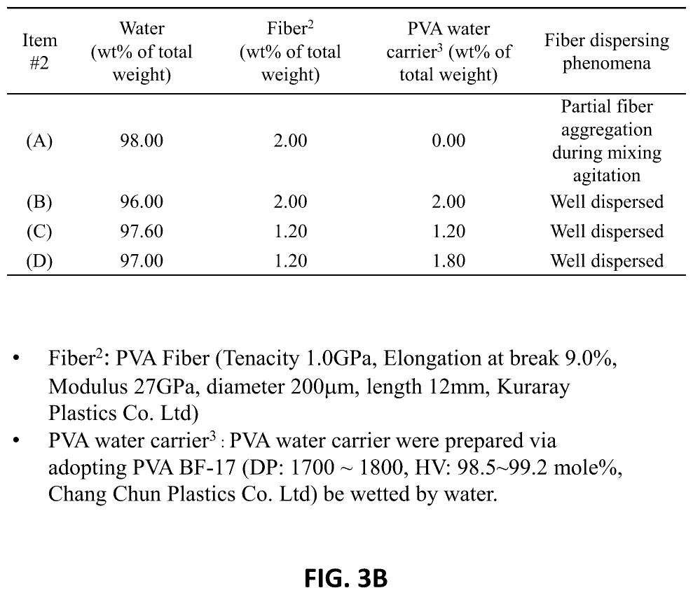

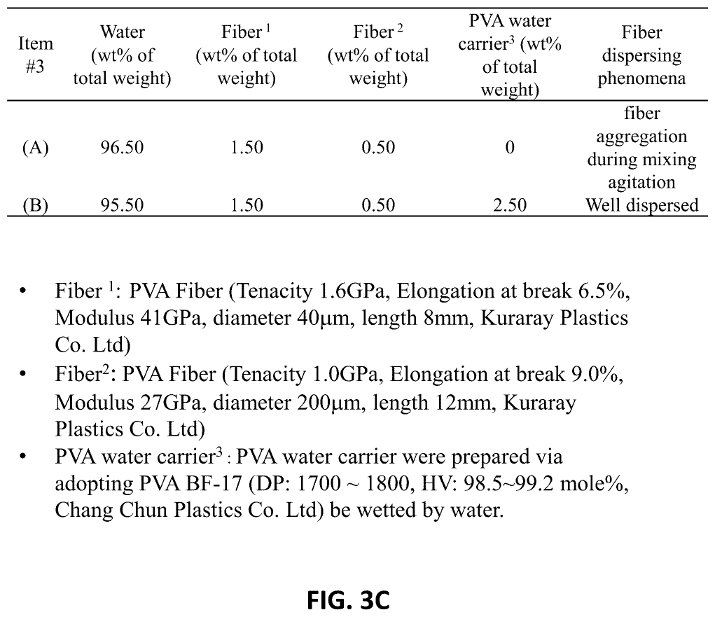

FIGS. 3A-3C show examples of observing fibers' dispersion phenomena in water.

Referring to FIGS. 3A-3C, in some embodiments, PVA fibers with various specifications are selected, wherein PVA fibers are added into the water inside a mixer with agitation. A suitable power density may be supplied from the agitation to check if the liquid medium can separate the fibers well.

As shown in FIG. 3A, the Fiber¹ may be PVA Fiber having Tenacity of 1.6 GPa, Elongation at break 6.5%, Modulus 41 GPa, diameter 40 mm, length 8 mm, and the PVA water carrier³ may be PVA water carriers prepared via adopting PVA BF-17 (DP: 1700˜1800, HV: 98.5˜99.2 mole %, Chang Chun Plastics Co. Ltd) wetted by water. Continuing to FIG. 3A, comparing Item #1 (A) and Item #1 (B), the PVA water carriers³ may cause the fiber to have good dispersion in the water. Comparing Item #1(B) with Item #1 (C) and Item #1 (D), the wt % of the PVA water carriers may be increased with respect to the wt. % of the fiber. It should be noted that, without having the PVA water carriers in the water, the PVA fibers may be aggregated or clumped.

As shown in FIG. 3B, Fiber² may be PVA Fiber having Tenacity of 1.0 GPa, Elongation at break 9%, Modulus 27 GPa, diameter 200 μm, length 12 mm, and the PVA water carrier³ may be PVA water carriers prepared via adopting PVA BF-17 (DP: 1700˜1800, HV: 98.5-99.2 mole %, Chang Chun Plastics Co. Ltd) wetted by water. It should be noted that the diameter of Fiber² is smaller than the diameter of Fiber¹. Continuing to FIG. 3B, comparing Item #2 (A) and Item #2 (B), the PVA water carriers³ may cause the fiber to have good dispersion in the water. Comparing Item #2 (B) with Item #2 (C) and Item #2 (D), the wt. % of the PVA water carriers may be increased with respect to the wt. % of the fiber. It should be noted that, without having the PVA water carriers in the water, the PVA fibers may be aggregated or clumped.

As shown in FIG. 3C, two kinds of fibers, including Fiber¹ and Fiber² are added to the water. Compared with Item #3 (A) and Item #3 (B), the PVA water carrier³ may cause Fiber¹ and Fiber² well disperse in the water.

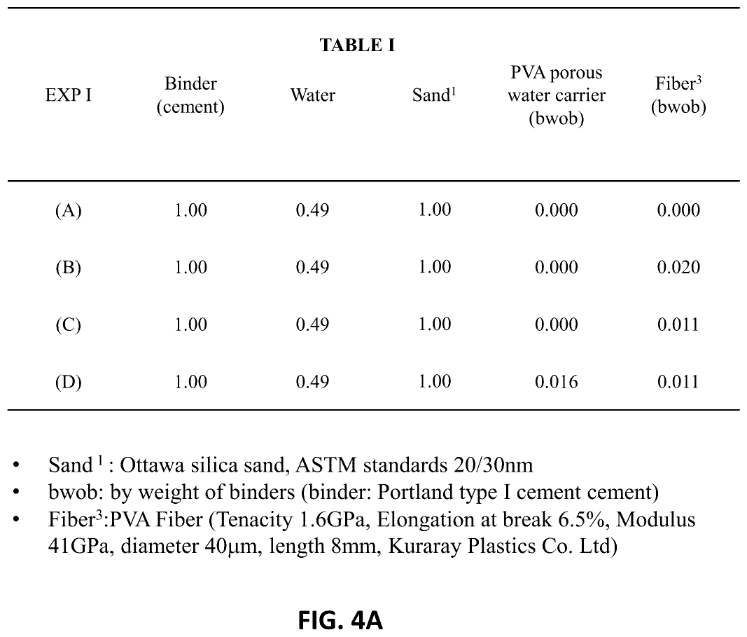

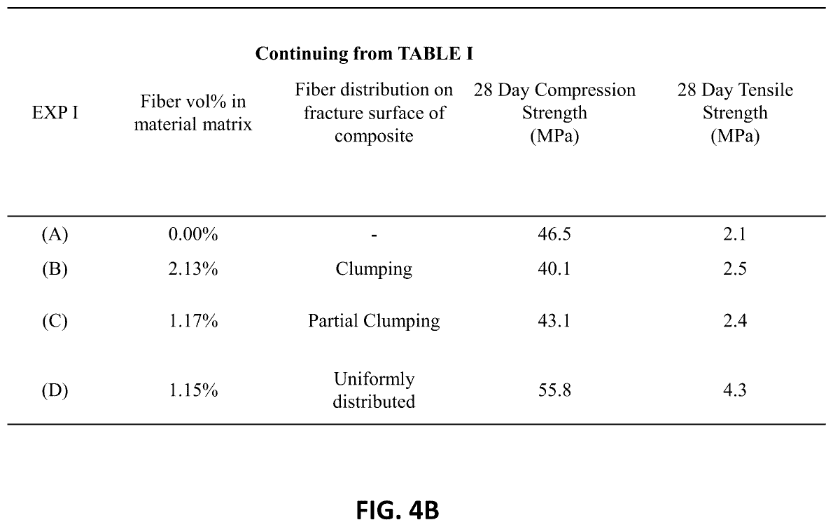

FIG. 4A illustrates the cementitious composite according to an aspect of the embodiments.

In some embodiments, the cementitious composite may comprise a weight ratio of the water to the cementitious binder (Ordinary Portland type I cement, average particle diameter: 4.7˜15.7 mm, supplied from Taiwan Cement Corp.) of 0.49:1. The weight ratio of the sand to the cementitious binder may be 1:1. As is well known, the weight ratio of sand or mineral such as sand or stone additive to the cementitious binder can vary considerably, depending on the intended application for the materials. The cementitious composite may also comprise a weight ratio of the chemical admixtures to the cementitious binder of 0.0025:1, wherein the chemical admixtures may comprise polyether type PCE water reducer having a solid content of 50.0 wt %. The cementitious composite may comprise a retarder including a mixture of monosaccharides and disaccharides, wherein the weight ratio of the retarder to the cementitious binder is 0.001:1. Also, the cementitious composite may also comprise a de-foaming agent with the weight ratio of the de-foaming agents to the cementitious binder of 0.001:1.

It should be noted that, in some embodiments, the cementitious binder may comprise the weight ratio of the cementitious binder to the PVA porous water carriers of zero which means adding no PVA porous water carriers (EXPI (A), EXPI (B), EXPI(C)) and a weight ratio of the PVA porous water carriers to the cementitious binder of 0.016:1 (EXPI (D)) and the weight ratio of the Fiber³ to the cementitious binder of zero which means no Fiber³ adding in the cementitious composite (EXPI (A)), 0.02:1 (EXPI (B)), and 0.011:1 (EXPI(C)) and EXPI (D)). Compared to EXPI (C) and EXPI (D), the PVA porous water carriers may significantly cause the Fiber³ to be uniformly distributed within the cementitious composite.

FIG. 4B shows that the cementitious composites of FIG. 4A are evaluated by the material compression strength test, followed by ASTM-C109 for material compression strength, and the material tensile strength test followed by ASTM-C307. In some embodiments, as shown in EXPI (B) and EXPI (C), while the Fiber³ is clumping, the tensile strength and the compression strength of the cementitious composites may be relatively lower. Comparing EXPI (C) and EXPI (D), FIG. 2A illustrates the EXPI (C), wherein while the cementitious composite has no PVA porous water carriers, Fiber³ is partially clumping as shown on a fracture surface. FIG. 2B illustrates the EXPI (D), wherein while the cementitious composite has PVA porous water carriers, Fiber³ is uniformly distributed as shown on a fracture surface.

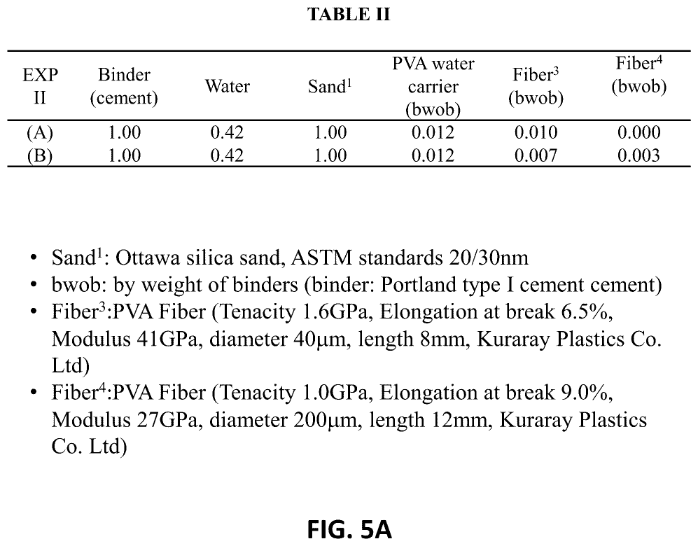

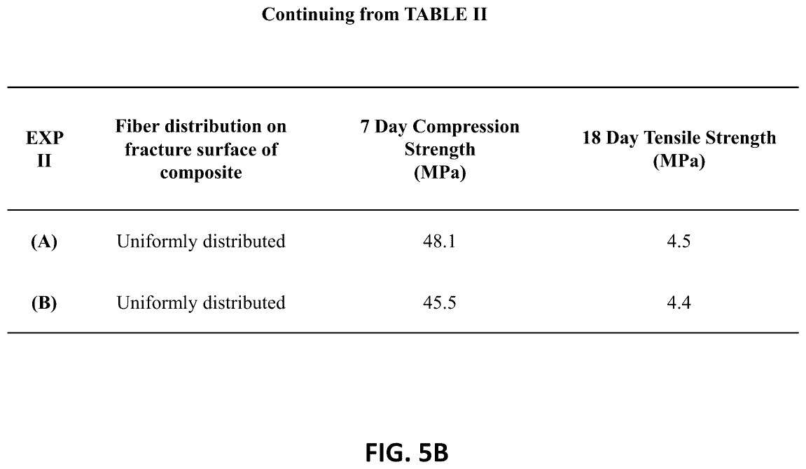

FIGS. 5A to 5B illustrates a combination of two kinds of fibers in the cementitious composite according to an aspect of the embodiments.

Referring to FIG. 5A to FIG. 5B, in some embodiments, the cementitious composite may comprise a weight ratio of the water to the cementitious binder (Ordinary Portland type I cement, average particle diameter: 4.7˜15.7 mm, supplied from Taiwan Cement Corp.) of 0.42:1. A weight ratio of the sand to the cementitious binder ratio may be 1:1. As is well known, the weight ratio of sand or mineral such as sand or stone additive to the cementitious binder can vary considerably, depending on the intended application for the materials. The cementitious composite may also comprise a weight ratio of the chemical admixtures to cementitious binder of 0.0026:1, wherein the chemical admixtures may comprise polyether type PCE water reducer having a solid content of 50.0 wt %. The cementitious composite may comprise a retarder including a mixture of monosaccharides and disaccharide, wherein the weight ratio of the retarder to cementitious binder is 0.001:1. Also, the cementitious composite may also comprise a de-foaming agent with the weight ratio of the de-foaming agents to the cementitious binder of 0.001:1.

In some embodiments, the cementitious composite may comprise Fiber³ and Fiber⁴. Continuing to FIG. 5B, the cementitious composite of EXPII (A) and EXPII (B) are evaluated by a 7-Day compression strength test and 18-day tensile strength test, and in this situation, the PVA porous water carriers may cause mixed fibers (Fiber³ and Fiber⁴) to be uniformly distributed within the cementitious composite.

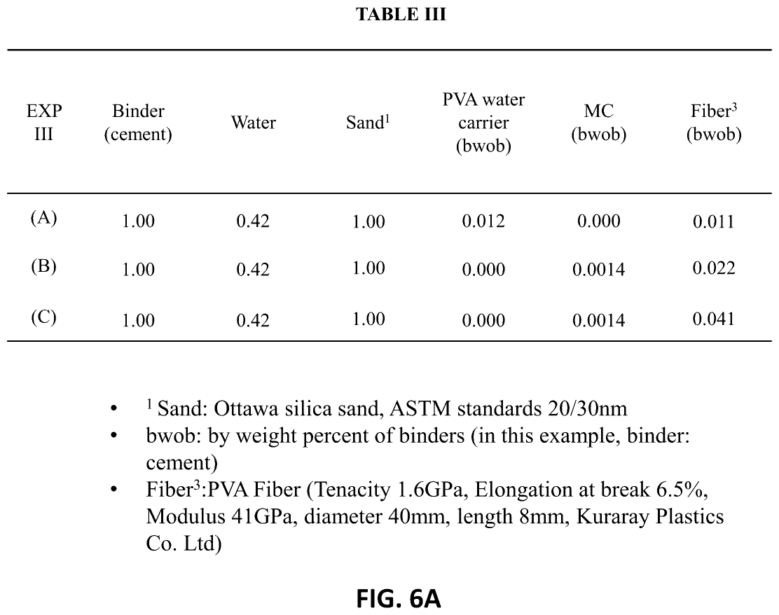

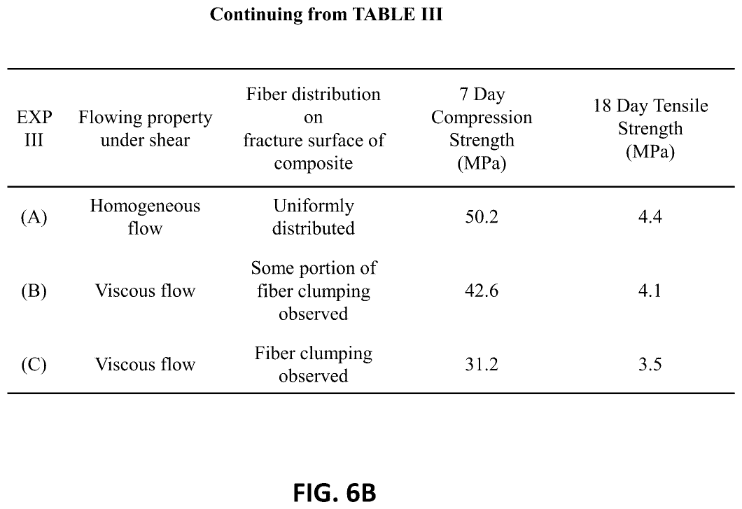

FIGS. 6A to 6B illustrate the comparations between adding the PVA porous water carriers and adding the viscosity modifying agent: methyl propyl cellulose (MC) in the cementitious composite according to an aspect of the embodiments.

Referring to FIGS. 6A to 6B, as shown in EXPIII (B) and EXPIII (C), the cementitious composite may comprise the viscosity modifying agent: methyl propyl cellulose (MC), and in such a situation, the cementitious composite may be performed as the viscous flow and the Fiber³ may be clumped as being observed on the fracture surface. As shown in further details in EXPIII (A), the cementitious composite may comprise PVA porous water carriers, and in such a situation, the cementitious composite may be performed as the homogeneous flow, and the Fiber³ may be uniformly distributed as observed on the fracture surface. It should be noted that, in some embodiments, the cementitious composite with the PVA porous water carriers may have higher compression strength and tensile strength than the cementitious composite with the viscosity modifying agent: methyl propyl cellulose (MC).

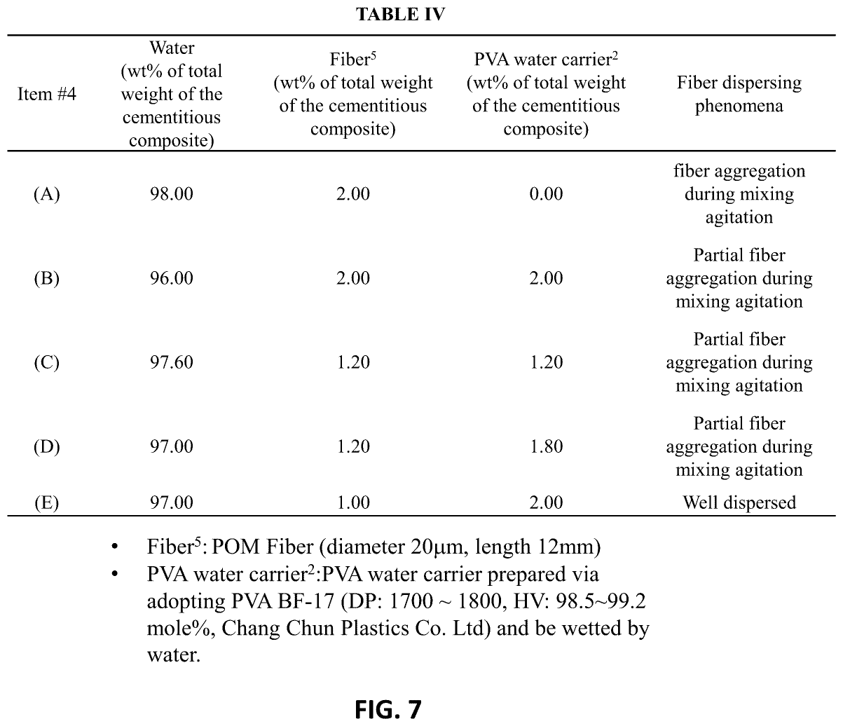

FIG. 7 illustrates that the PVA porous water carriers may cause the polyoxymethylene (POM) fibers to be well dispersed in the water according to an aspect of the embodiments.

Referring to FIG. 7, according to Item #4 (A), (B), (C), (D), the PVA porous water carriers may improve the polyoxymethylene (POM) fibers being well dispersed in the water.

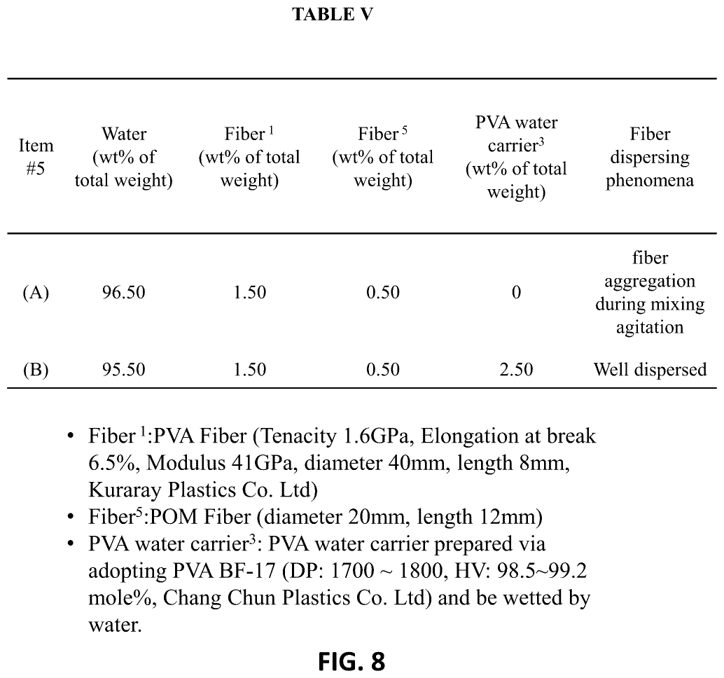

FIG. 8 illustrates that the PVA porous water carriers may cause the polyoxymethylene (POM) fibers and PVA fibers to be well dispersed in the water according to an aspect of the embodiments.

Referring to FIG. 8, according to Item #5 (A) and (B), the PVA porous water carriers may improve mixed fibers, including the polyoxymethylene (POM) fibers and PVA fibers being well dispersed in the water.

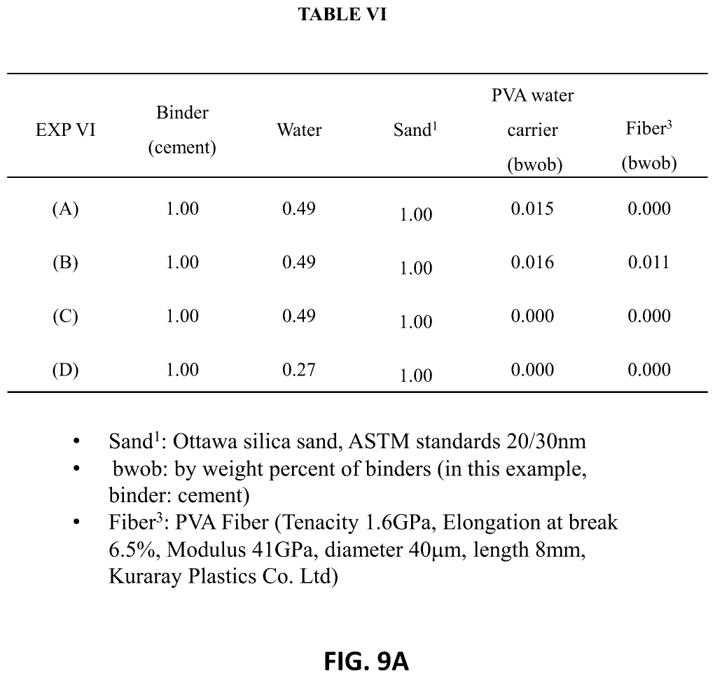

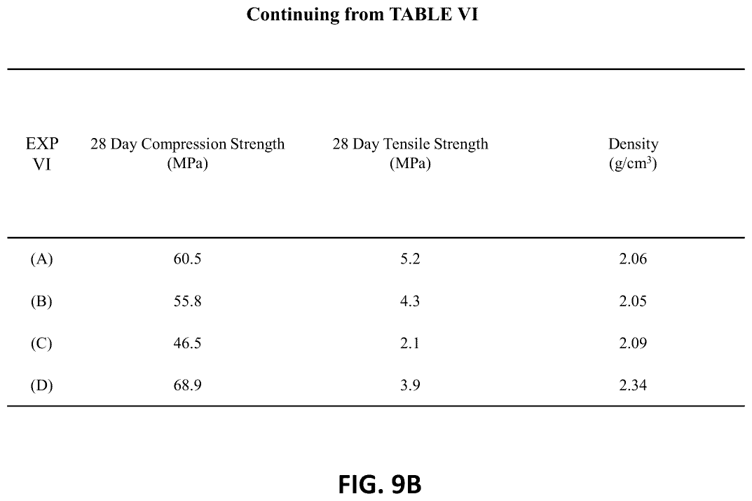

FIGS. 9A to 9B illustrates that the cementitious composite may have polymer fibers or without having polymer fibers according to an aspect of the embodiments.

Referring to FIG. 9A to FIG. 9B, in some embodiments, the cementitious composite may comprise a weight ratio of the water to the cementitious binder (Ordinary Portland type I cement, average particle diameter: 4.7˜15.7 mm, supplied from Taiwan Cement Corp.) of 0.49:1. A weight ratio of the sand to the cementitious binder ratio may be 1:1. As is well known, the weight ratio of sand or mineral such as sand or stone additive to the cementitious binder can vary considerably, depending on the intended application for the materials. The cementitious composite may also comprise a weight ratio of the chemical admixtures to cementitious binder of 0.0025:1, wherein the chemical admixtures may comprise polyether type PCE water reducer having a solid content of 50.0 wt %. The cementitious composite may comprise a retarder including a mixture of monosaccharides and disaccharide, wherein the weight ratio of the retarder to the cementitious binder is 0.001:1. Also, the cementitious composite may also comprise a de-foaming agent with the weight ratio of the de-foaming agents to the cementitious binder of 0.001:1.

In still some embodiments, as shown in EXP VI (A) and EXP VI(B), without having Fiber³, the cementitious composite may have higher compression strength and higher tensile strength. As shown in EXP VI (A) and EXP VI (D), while the cementitious composite has a lower weight ratio of the water to the cementitious binder of 0.27:1 (EXP VI (D)), the cementitious composite may have higher compression strength, but the tensile strength is lower than the tensile strength of EXP VI (A), and in such a way, using PVA water carriers in the cementitious composite (EXP VI (A)), may significantly increase the tensile strength. It should be noted that, see EXP VI(D), while the cementitious composite has a lower weight ratio of the water to the cementitious binder of 0.27:1, the density of the cementitious composite may be higher than EXP VI (A) and EXP VI(B), and at this situation, the PVA water carriers in EXP VI (A) and EXP VI(B) may decrease the density of EXP VI (A) and EXP VI(B).

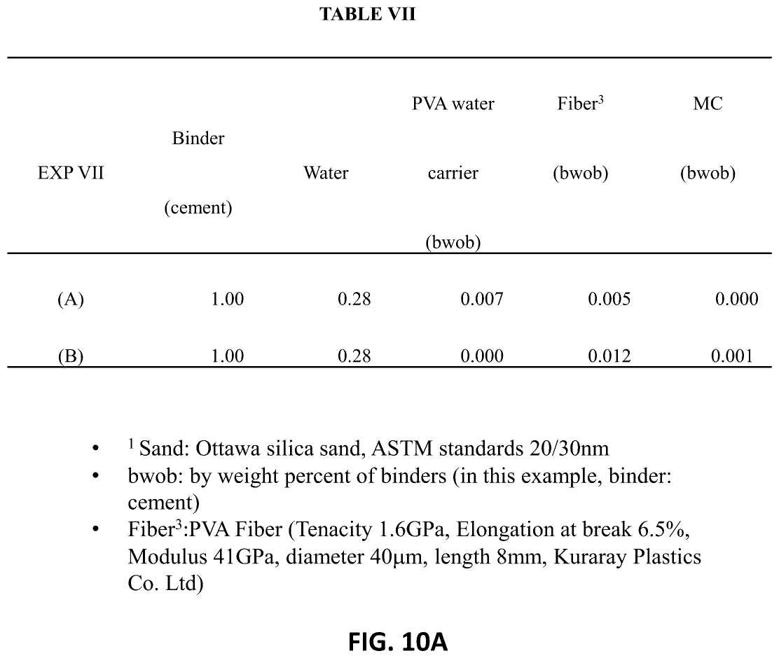

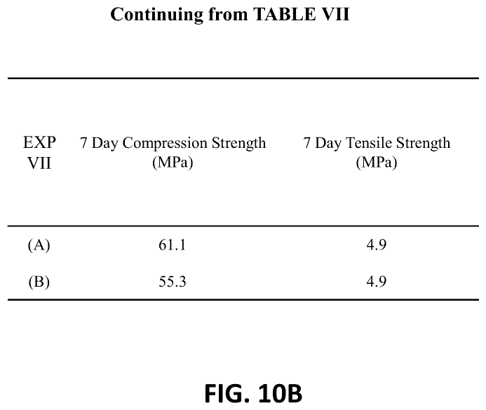

FIGS. 10A to 10B illustrate that the cementitious composite without having aggregates according to an aspect of the embodiments.

Referring to FIGS. 10A and 10B, as shown in EXP VII (A) and EXP VII(B), while the cementitious composites comprise no aggregates and a lower weight ratio of the water to the cementitious binder of 0.28:1, the viscosity of the cementitious composites may be relatively higher, and the PVA water carriers may cause the Fiber³ being well dispersed, and at such a situation, the cementitious composites (EXP VII (A) and EXP VII(B)) may have relatively higher compression strength and tensile strength.

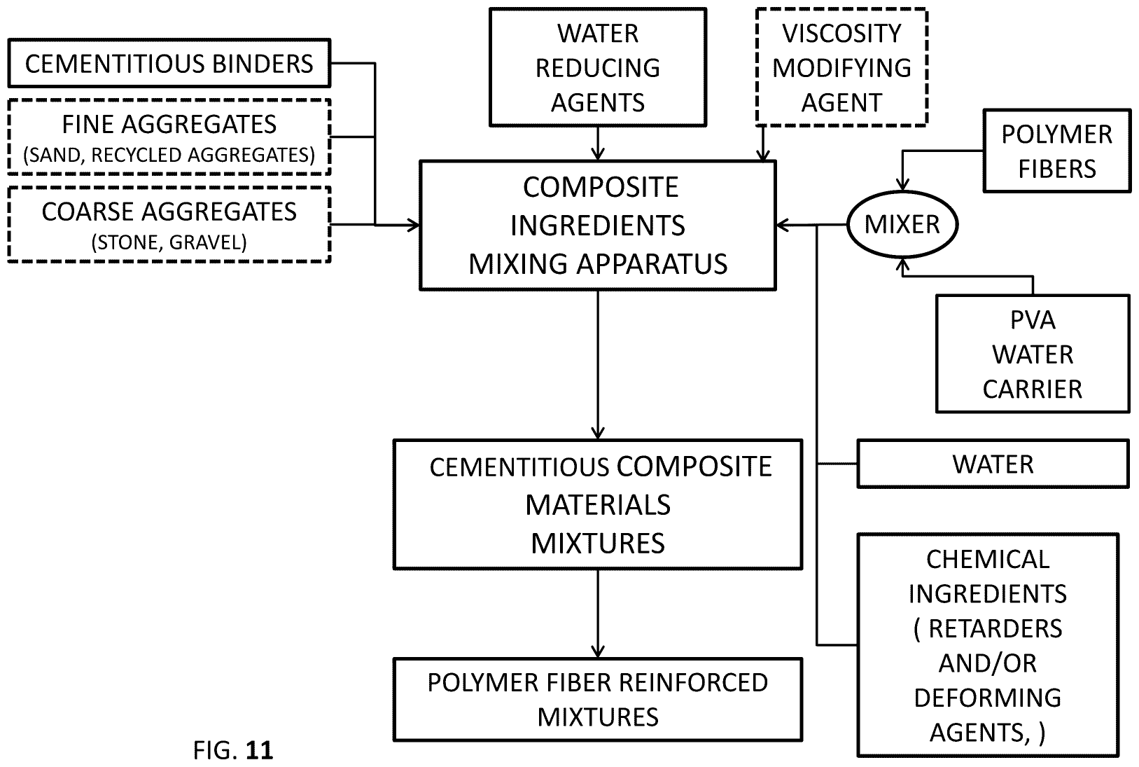

FIG. 11 generally depicts a method of making the cementitious composite according to an aspect of the embodiments.

Referring to FIG. 11, the method of making the cementitious composite may comprise:
blending cementitious binders, and selectively aggregates, including fine aggregates and coarse aggregate to form a dry mixture;
separately blending polymer fibers and PVA porous water carriers different than the polymer fibers in a mixer to form a reinforced mixture;
blending water, water reducing agents, the dry mixture, and the reinforced mixture to form a polymer fiber reinforced mixture;
molding, hardening, and demolding the polymer fiber-reinforced mixture to form a cementitious composite, wherein the cementitious composite has from 0.5 to 3.0 vol % of polymer fibers, a weight ratio of the water to the cementitious binder in a range of 0.3:1 to 0.55:1, a weight ratio of the PVA porous water carriers to the cementitious binder weight ratio in a range of 0.005:1 to 0.03:1, and a weight ratio of the water reducing agents to the cementitious binder ratio in a range of 0.001:1 to 0.05:1.

In some embodiments, the method may further comprise a step of adding the viscosity modifying agent in the reinforced mixture, wherein the cementitious composite has the weight ratio of the viscosity modifying agent to the cementitious weight in a range of 0.0014:1 to 0.025:1. It should be noted that, in some embodiments, the viscosity modifying agent comprises methyl propyl cellulose.

In some embodiments, the method may further comprise a step of blending the cementitious binders with aggregates to form a dry mixture, wherein a weight ratio of the aggregates to the cementitious binder may be in a range of 0.01:1 to 9:1, wherein the aggregates may comprise fine aggregates and coarse aggregates.

In some embodiments, the method may further comprise a step of adding chemical ingredients in the reinforced mixture, wherein a weight ratio of the chemical ingredients to the cementitious binder may range from 0.001:1 to 0.025:1.

In some embodiments, the method may further comprise a step of adding water reducing agents in the reinforced mixture, wherein the water reducing agents comprise solid contents including active PCE polymers and solid fillers including powder or pellets in a range of above 20 wt % and are selected from the group consisting of polycarboxylate (PCE), polycarbonate, lignosulfonate, sodium naphthalene sulfonate-formaldehyde condensate, melamine sulfonate-formaldehyde condensate, poly-alkylaryl sulfonate and a combination thereof.

In still some embodiments, the fine aggregates comprise sands and recycled aggregates, and the coarse aggregates comprise stones and gravels.

In still some embodiments, for example, in construction, fine aggregates may be the fillers or particles that pass through a 4.75 mm sieve and retain on a 0.075 mm sieve, and the coarse aggregates may be the fillers or particles whose size are greater than 4.75 mm.

In still some embodiments, the chemical ingredients are selected from a group consisting of chemicals bringing hydroxyl groups (R—OH), saccharides, monosaccharides including glucose, fructose, galactose, saccharose, xylose, apiose, and ribose and high-fructose corn syrup, oligosaccharides including di-saccharides and tri-saccharides, oligosaccharides including dextrin, and polysaccharides including dextran, and refinery saccharides, sugar alcohols including sorbitol polyhydric alcohols and glycerin and a combination thereof.

In still some embodiments, the method further comprises a step of pre-wetting PVA powder, pellet, or particles by water or organic solvents with C—OH functional group to form the PVA porous water carriers, wherein the PVA powders, pellets, or particles have a degree of polymerization (DP) from 1000 to 2500 and a degree of hydrolysis value (HV, mole %) from 87.0 mole % to 99.9 mole %.

In still some embodiments, the cementitious composite comprises a weight ratio of the PVA (polyvinyl alcohol) porous water carriers to polymer fibers in a range of 1:1 to 1.5:1. In still some embodiments, the polymer fibers comprise a tenacity of 1.0 to 1.6 GPa, an elongation of 6-9.5%, a Modulus of 27 GPa to 41 GPa, a diameter of 20 to 220 μm, and a length of 5 to 15 mm.

In still some embodiments, the cementitious binder has an average particle diameter from 4.5 to 16.0 mm and is selected from a group consisting of Portland type I cement, Portland type II cement, Portland type III cement, lime, slag, flying ash, refractory cement, pozzolanic cement, and a combination thereof.

In still some embodiments, the cementitious composite may without comprising viscosity modifying agents including methyl propyl cellulose and/or may without comprising aggregates, including fine aggregates and coarse aggregates.

Similarly, while operations and/or methods may be depicted in the drawings in a particular order, this should not be understood as requiring that such operations be performed in the particular order shown or in sequential order, or that all illustrated operations and/or methods steps be performed, to achieve desirable results. In certain circumstances, multitasking and parallel processing may be advantageous.

Accordingly, taking advantage of the above-mentioned cementitious composite through incorporating PVA porous water carriers and associated methods for making thereof, these kinds of new cementitious composite may be extensively applied in fields of civil engineering such as cementitious adhesives, cementitious pastes and mortars, fiber-reinforced mortars, ready-mix concretes, high strength performance concrete, self-compacting concrete (SCC), pre-casting concrete, FRC, ECC, and the like. The above cementitious composite may be further designed or constructed in modern environmentally friendly buildings or civil engineering structures with low carbon emissions, such as walls, floors, flat slabs, supporting beams, and columns, as well as for manufactured elements such as extruded pressure pipes and tubing, and the like.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more, or different elements, which are disclosed herein even when not initially claimed in such combinations.

Thus, specific embodiments and applications of cementitious composite co-containing polyvinyl alcohol water carriers and reinforced fibers and methods for making thereof have been disclosed. It should be apparent, however, to those skilled in the art that many more modifications besides those already described are possible without departing from the disclosed concepts herein. The disclosed embodiments, therefore, are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A cementitious composite comprising,
a cementitious binder;
water;
from 0.5 to 2.0 vol % of polymer fibers;
water reducing agents, and
PVA (polyvinyl alcohol) porous water carriers different than the polymer fibers; wherein
the cementitious composite has a weight ratio of the water to the cementitious binder in a range of 0.30:1 to 0.55:1, a weight ratio of the PVA porous powder water carriers to the cementitious binder in a range of 0.005:1 to 0.03:1, and a weight ratio of the water reducing agents to the cementitious binder in range of 0.001:1 to 0.05:1.

2. The cementitious composite of claim 1, wherein the cementitious composite has a weight ratio of viscosity modifying agents including methyl propyl cellulose to the cementitious binder in a range of 0.0014:1 to 0.025:1 and a weight ratio of aggregates to the cementitious binder in a range of 0.01:1 to 9:1, and a weight ratio of chemical ingredients including slump keeper, retarder, de-foaming agents or a combination thereof to the cementitious binder in a range of 0.001:1 to 0.025:1.

3. The cementitious composite of claim 1, wherein the polymer fibers comprise a tenacity of 1.0 to 1.6 GPa, an elongation of 6-9.5%, a Modulus of 27 GPa to 41 GPa, a diameter of 20 to 220 μm, and a length of 5 to 15 mm.

4. The cementitious composite of claim 1, wherein the cementitious composite comprises aggregates without aggregates including fine aggregates and coarse aggregates, and without viscosity modifying agents including methyl propyl cellulose.

5. The cementitious composite of claim 1, wherein water reducing agents comprise solid contents including active PCE polymers and powers or pellets in a range of above 20 wt % by the total weight of the water reducing agents and are selected from the group consisting of polycarboxylate (PCE), polycarbonate, lignosulfonate, sodium naphthalene sulfonate-formaldehyde condensate, melamine sulfonate-formaldehyde condensate, poly-alkylaryl sulfonate and a combination thereof.

6. The cementitious composite of claim 1, wherein the PVA porous water carriers comprise PVA powder, pellet, or particles wetted by water or organic solvents with C—OH functional group, wherein the PVA powders, pellets, or particles have a degree of polymerization (DP) from 1000 to 2500 and a degree of hydrolysis value (HV, mole %) from 87.0 mole % to 99.9 mole %.

7. The cementitious composite of claim 2, wherein the aggregates comprise fine aggregates and coarse aggregates, wherein the fine aggregates comprise sands with ASTM standards 20/30 nm and recycled aggregates and the coarse aggregates comprise stones and gravels.

8. The cementitious composite of claim 1, wherein the cementitious binder has an average particle diameter from 4.5 to 16.0 mm and is selected from a group consisting of Portland type I cement, Portland type II cement, Portland type III cement, lime, slag, flying ash, refractory cement, pozzolanic cement, and a combination thereof.

9. The cementitious composite of claim 2, wherein the chemical ingredients are selected from a group consisting of chemicals bringing hydroxyl groups (R—OH), saccharides, monosaccharides including glucose, fructose, galactose, saccharose, xylose, apiose, and ribose and high-fructose corn syrup, oligosaccharides including di-saccharides and tri-saccharides, oligosaccharides including dextrin, and polysaccharides including dextran, and refinery saccharides, sugar alcohols including sorbitol polyhydric alcohols and glycerin and a combination thereof.

10. The cementitious composite of claim 1, further comprising a weight ratio of the PVA (polyvinyl alcohol) porous water carriers to the polymer fiber of from 0.5:1 to 3:1.

11. A method of making a cementitious composite, comprising:
blending a cementitious binder and selectively aggregates to form a dry mixture;
separately blending polymer fibers and PVA porous water carriers different than the polymer fibers in a mixer to form a reinforced mixture;
blending water, water-reducing agents, the dry mixture, and the reinforced mixture to form a polymer fiber reinforced mixture;
molding, hardening, and demolding the polymer fiber-reinforced mixture to form a cementitious composite; wherein
the cementitious composite has from 0.5 to 2.0 vol % of polymer fibers, a weight ratio of the water to the cementitious binder of 0.3:1 to 0.55:1, a weight ratio of the PVA porous powder water carriers to the cementitious binder of 0.005:1 to 0.03:1, and a weight ratio of water reducing agents to the cementitious binder in a range of 0.001:1 to 0.05:1.

12. The method of claim 11, further comprising a step of adding the viscosity modifying agents, including methyl propyl cellulose to the reinforced mixture, wherein the cementitious composite has a weight ratio of the viscosity modifying agent to the cementitious binder in a range of 0.0014:1 to 0.025:1, and a weight ratio of aggregates to the cementitious binder in a range of 0.01:1 to 9:1.

13. The method of claim 11, wherein the water reducing agents comprise solid contents including active PCE polymers and powers or pellets in a range of above 20 wt % by the total weight of the water-reducing agents and are selected from the group consisting of polycarboxylate (PCE), polycarbonate, lignosulfonate, sodium naphthalene sulfonate-formaldehyde condensate, melamine sulfonate-formaldehyde condensate, poly-alkylaryl sulfonate and a combination thereof.

14. The method of claim 11, wherein the aggregates comprise fine aggregates including sands with ASTM standards 20/30 nm and recycled aggregates, and coarse aggregates including stones and gravels.

15. The method of claim 11, further comprising a step of adding the chemical ingredients, including slump keeper, retarder, de-foaming agents, or a combination thereof to the reinforced mixture, wherein a weight ratio of the chemical ingredients to the cementitious binder in a range of 0.001:1 to 0.025:1 without adding aggregates including fine aggregates and coarse aggregates and viscosity modifying agents including methyl propyl cellulose

16. The method of claim 15, wherein the chemical ingredients are selected from a group consisted of chemicals bringing hydroxyl groups (R—OH), saccharides, monosaccharides including glucose, fructose, galactose, saccharose, xylose, apiose, and ribose and high-fructose corn syrup, oligosaccharides including di-saccharides and tri-saccharides, oligosaccharides including dextrin, and polysaccharides including dextran, and refinery saccharides, sugar alcohols including sorbitol polyhydric alcohols and glycerin and a combination thereof.

17. The method of claim 11, further comprising a step of pre-wetting PVA powder, pellet, or particles by water or organic solvents with C—OH functional group to form PVA porous water carriers, wherein the PVA powders, pellets, or particles has a degree of polymerization (DP) from 1000 to 2500 and a degree of hydrolysis value (HV, mole %) from 87.0 mole % to 99.9 mole %.

18. The method of claim 11, wherein the cementitious composite comprises a weight ratio of the PVA (polyvinyl alcohol) porous water carriers to the polymer fibers from 0.5:1 to 3:1.

19. The method of claim 11, wherein the polymer fibers comprise a tenacity of 1.0 to 1.6 GPa, an elongation of 6-9.5%, a Modulus of 27 GPa to 41 GPa, a diameter of 20 to 220 μm, and a length of 5 to 15 mm.

20. The method of claim 11, wherein the cementitious binder has an average particle diameter from 4.5 to 16.0 mm and is selected from a group consisting of Portland type I cement, Portland type II cement, Portland type III cement, lime, slag, flying ash, refractory cement, pozzolanic cement, and a combination thereof.
